(19) United States
(12) Patent Application Publication
(10) Pub. No.: US 2017/0118344 A1
(43) Pub. Date: Apr. 27, 2017

(54) ATTENTIVE ASSISTANT

(71) Applicant: Semantic Machines, Inc., Newton, MA (US)

(72) Inventors: Jordan R. Cohen, Kure Beach, NC (US); Daniel L. Roth, Newton, MA (US); David Leo Wright Hall, Berkeley, CA (US); Jesse Daniel Eskes Rusak, Somerville, MA (US); Andrew Robert Volpe, Boston, MA (US); Sean Daniel True, Natick, MA (US); Damon R. Pender, Amesbury, MA (US); Laurence S. Gillick, Newton, MA (US); Yan Virin, Foster City, CA (US)

(21) Appl. No.: 15/298,475

(22) Filed: Oct. 20, 2016

Related U.S. Application Data
(60) Provisional application No. 62/244,417, filed on Oct. 21, 2015.

(51) Int. Cl. H04M 3/527; H04L 29/06

(52) U.S. Cl. CPC H04M 3/527; H04L 65/1069; H04L 65/608

(57) ABSTRACT

An approach to providing communication assistance to an operator of a vehicle makes use software having a first component executing on a personal device of the operator as well as a second component executing on a server in communication with the personal device. In some implementations, handling a call involves establishing a first two-way audio link between the server and the calling device is established, and a second two-way audio link between a server and the user device. The server passes some of the audio from the calling device to the user device, and monitors a user's voice input, of lack thereof, to determine how to handle the call.

### CROSS-REFERENCE TO RELATED APPLICATIONS

This application claims the benefit of U.S. Provisional Application No. 62/244,417, filed Oct. 21, 2015, titled “THE ATTENTIVE ASSISTANT.” This application is incorporated herein by reference.

### BACKGROUND

This invention relates to a communication assistant, and in particular to an automated assistant for use by an operator of a motor vehicle, or of other equipment, in performing communication related tasks.

Mobile devices are ubiquitous in today's connected environment. There are more cell phones in the United States than there are people. Drivers often use mobile communications to transact business, to provide access to social media, or for other personal communications tasks. Some states have legislated for the use only of hands-free communication devices in cars, but scientific studies of distracted driving suggest that this constraint does not free the driver of substantial distraction. The growing rise of text communications among younger people has further exacerbated the problem, with findings that as many as 30% of traffic accidents are caused by texting-while-driving users.

Mobile devices today may include voice-based interfaces, for instance, the Siri™ interface provided by Apple Inc., which may allow users to interface with their mobile devices using hands-free voice-based interactions. For example, a user may place a telephone call or dictate a text message by voice. Speech-recognition based telephone assistants have been attempted but are not ubiquitous. For example, a system developed by Wildfire Communication over twenty years ago attempted to provide telephone-based assistance, but did not relive the user of having to use a conventional telephone to interact with the system. However, drivers may be distracted using such interfaces even if a hands-free telephone is used.

### SUMMARY

In a general aspect, an approach to providing communication assistance to an operator of a vehicle makes use software having a first component executing on a personal device of the operator as well as a second component executing on a server in communication with the personal device.

In one aspect, a method for assisting communication via a user device includes receiving at a server a voice-based call from a calling device for the user device, the voice-based call having been made to an address associated with the user device. A first two-way audio link between the server and the calling device is established. A second two-way audio link is also established between a server and the user device. The server responds to the call by sending a first audio stream over the first link to the calling device. The first audio stream includes a spoken message for alerting a calling party to the involvement of an automated assistant. The server receives a second audio stream over the first link from the calling device, and sends a third audio stream over the second link to the user device, where the third audio stream includes a portion of the second audio stream. Audio received over at least one of the first link and the second link is processed at the server. This processing includes waiting to receive a first voice response of a first predetermined type over the second link, and if the first voice response is received, causing the calling device and the user device to be joined by a two-way audio link.

Aspects may include one or more of the following features.

The sending of the third audio stream is performed at least in part during receiving of the second audio stream.

The third audio stream is a delay of the second audio stream.

The voice response from the user device is not sent to the calling device.

The first voice response consists of no spoken response (i.e., the user does not speak, for example, for a prescribed amount of time).

Processing the audio further includes waiting to receive a second voice response of a second predetermined type over the second link, and if the second voice response is received, causing the calling device and a voice messaging server to be joined by a two-way audio link.

Establishing the second link is performed prior to receiving the voice-based call.

The second link comprises a packet-based link (e.g., a WebRTC based link).

Causing the calling device and the user device to be joined by a two-way audio link comprises bridging the first link and the second link, or redirecting the voice-based call to the user device.

In another aspect, in general method for assisting communication via a user device includes establishing a second two-way audio link between a server and a user device. A call made to the user device (e.g., from a calling device to a number for the user device) at the user device, including by receiving a third audio stream over the second link, where the third audio stream includes a portion of the second audio stream received from a calling device at the server. Audio received at the user device from a user is processed, including receiving a first voice response of a first predetermined type, wherein first voice response causes the calling device and the user device to be joined by a two-way audio link.

Aspects may include one or more of the following features.

The receiving of the third audio stream is performed at least in part during receiving of the second audio stream at the server.

The third audio stream is a delay of the second audio stream.

Establishing the second link is performed to the server receiving the second audio stream.

An advantage of one or more embodiments is that the there is little if any distraction to the user to cause a call to be either competed from a calling device to the user device or directed to a voice messaging system. In a particularly simple embodiment, in response to “eavesdropping” on an interaction between the assistant and the caller, the requirement that the user is merely silent to cause the call to be redirected or to utter a simple command to complete the call provides a high degree of functionality with minimal distraction. More complex command input by the user can provide increased functionality without increasing distraction significantly.

Other features and advantages of the invention are apparent from the following description, and from the claims.

### DESCRIPTION OF DRAWINGS

FIG. 1 is a block diagram of a communication assistance system;

FIG. 2 is a block diagram of components of the system of FIG. 1.

### DESCRIPTION

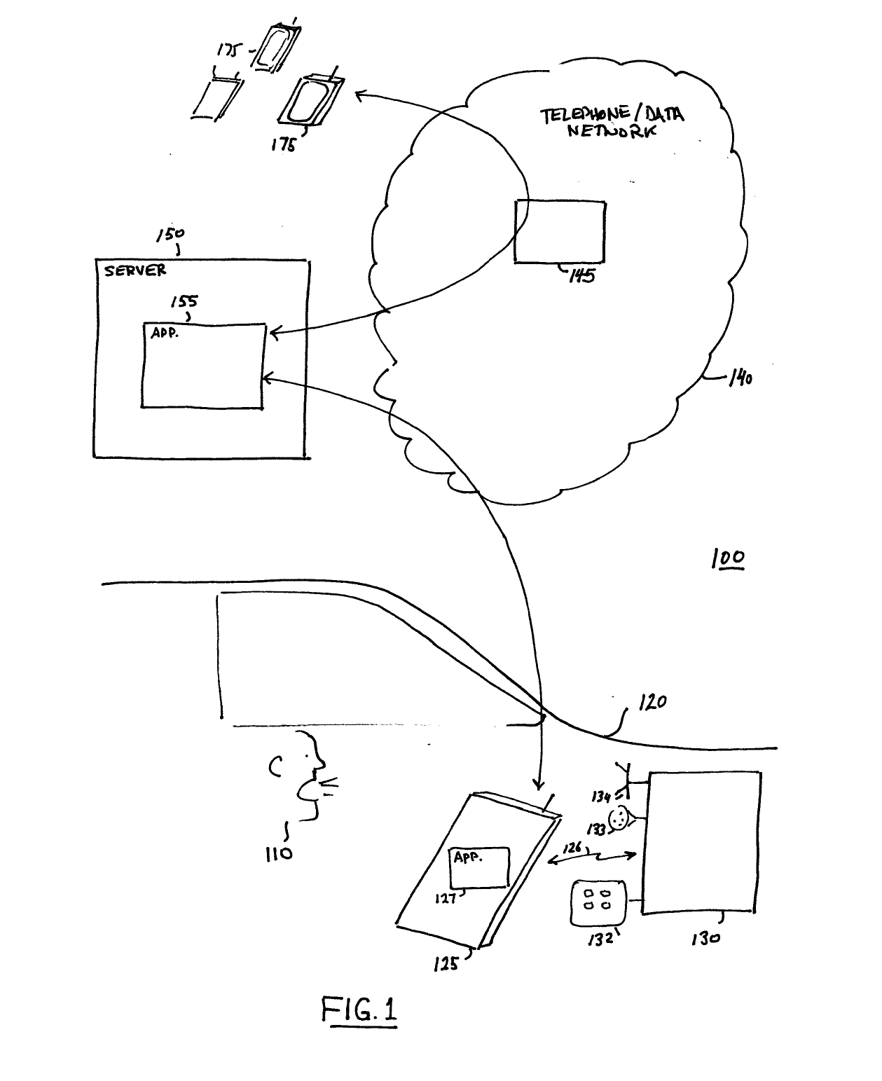

FIG. 1 shows a schematic block diagram of a communication assistance system 100. A representative vehicle 120 is illustrated in FIG. 1, as are a set of representative remote telephones 175 (or other communication devices), but it should be understood that the system described herein is intended to support a large population of users. Generally, a user 110, generally an operator of a vehicle 120, makes use of a personal device 125, such as a “smartphone”. The device 125 includes a processor that can execute applications, and in particular, executes a client application 127, which is used in providing communication assistance to the user. The vehicle 120 may optionally include a built-in station 130, which communicates with the personal device 125 (e.g., via a Bluetooth radio frequency communication link 126) and extends interface functions of the personal device via a speaker 134, microphone 133, and/or touchscreen 132.

The personal device 125 is linked to a telephone and data network 140, for example, that includes a cellular based “3G” or “4G”/“LTE” network that provides communication services to the device, including call-based voice communication (i.e., a dedicate channel for voice data) and/or packet or message based communication.

The system 100 makes use of one or more server computers 150, which execute a server application 155. In general, the client application 127 executing on the user's personal device 125 is in data and/or voice based communication with the server application 155 during the providing of communication assistance to the user.

The user's device is associated a conventional telephone number and/or other destination address (e.g., email address, Session Initiation Protocol (SIP) Uniform Resource Identifier (URI), etc.) based on which other devices, such as remote telephone 175 can initiate communication to the user's personal device 125. Communication based on a conventional telephone number is described as a typical example.

In general, inbound communication, for example, from a remote telephone 175 is redirected to the server application 155 at the server 150. In one approach, such redirection is selected by the user 110 when the user is operating the vehicle 120, or in some examples, redirection is initiated automatically when the personal device is used in the vehicle (e.g., paired with the built-in station 130). One way that this redirection is accomplished is for the client application 127 executed on the personal device 125, and to communicate with a component 145 (e.g., a switch, signaling node, gateway, etc.) of the telephone network to cause the redirection on inbound communication to the personal device. Various approaches to causing this redirection may be used, at least in part dependent on the capabilities of the telephone network 140. For example, in certain networks, the redirection may be turned on and off using dialing codes, such as “*72” to turn on forwarding and “*73” to turn it off. In embodiments, rather than the client application 127 causing the redirection, the user may use built-in capabilities of the personal device 125 to cause the redirection, for example, using a “Settings>Phone>Call Forwarding” setting of a smartphone. In any case, calls and optionally text messages are directed to the server application 155 as a result. The server application 155 does not necessarily have a separate physical telephone line for each user 110. For example, dialed number information (DNIS) or other signaling information may be provided by the telephone network 140 when delivering a call for the user to the server application 155 in order to identify the destination (i.e., the user) for the call. In some implementations (not shown in FIG. 1), inbound communication may pass through a Voice-over-IP (VoIP) gateway in or at the edge of the network 140, and call setup as well as voice data may be provided to the server application 155 over a data network connection (e.g., as Internet Protocol communication).

Prior to receiving communication at the server application 155 for the user 110, a persistent data connection is established between the server application 155 and the client application 127, or alternatively, the client application 127 can accept new data connections that are initiated on demand by the server application 155 over a data network linking the server 150 and the personal device 125 (e.g., over a data network service of the mobile network 140).

When a voice call is received at the server application 155 for a particular user 110, the server accepts the call and establishes a voice communication channel between the server application and the remote telephone 175, making use of speech synthesis (either from recorded utterances, or using computer-implemented text-to-speech (TTS)) and speech recognition and/or telephone tone (DTMF) decoding capabilities at the server application 155. Handling of a received voice call by the server application generally involves audio communication between the server application and the calling telephone 175 on a first communication link, as well as audio communication between the user 110 and the server application 155 on a second communication link. In one implementation, audio communication between the server application 155 and the user 110 makes use of a peer-to-peer audio protocol (e.g., WebRTC and/or RTP) to pass audio between the server application 155 and the client application 127. The client application 127 interacts with the user via a microphone and speaker of the device 125 and/or the station 130. Depending on the flow of call handling, as described more fully below, the calling telephone 175 and the personal device 125 may at some point in the flow be linked by a bidirectional voice channel, for example, with the channel being bridged at the server application 155, or bridged or redirected via capabilities provided by the telephone network 140.

In general, handling of an inbound telephone call involves the server application 155 performing steps including: (1) answering the call; (2) communicating with the caller advising the caller of its assistant nature; (3) announcing the call to the user 110, generally including forwarding of at least some audio of the communication with the caller to the user; and (4) causing the caller and the user to be in direct audio communication (e.g., bridging the call to include the caller, the server, and the in-vehicle user) or forwarding to to a voicemail repository, depending on the actions of the driver.

In an example of handling of an inbound call, a call made to the user's telephone number while the user is using the system in the user's vehicle is delivered to the server application 155. The server application implements the assistant function, and upon answering the call, the assistant announces itself, for instance, by saying “this is the assistant for [driver's ID]. May I help you?” The caller may respond by saying “I'd like to speak with [driver's ID]”, whereupon the assistant generates an audio response that says “He is driving. I'll see if he can take your call”. During this exchange with the caller (or optionally with a delay or after the completion of the interaction), the server application forwards the audio to the client application 127 in the vehicle, and the client application plays the audio (e.g., both the server application synthesized prompts as well as the caller's audio answers). After this initial exchange, the assistant waits a few seconds for the driver to speak. This functionality may be implemented at the client application 127, or alternatively, the monitored audio from within the vehicle may be passed to the server application 155, which makes this determination. In any case, this audio from the vehicle is not generally passed back to the caller. Not hearing any response from the driver, the assistant then generates another audio response that says “[driver ID] is busy; may I forward your call to his voicemail?” If the caller speaks, the assistant detects the caller's verbal response and processes the response. If the driver speaks in response to the assistant's prompt indicating that the call should be completed, then the assistant connects the device 125 to the call, and the phone call proceeds normally. If the driver does not speak, or indicates that he cannot accept the call, the call is directed to voicemail. As introduced above, the connection of the call to the user may be performed in a variety of ways, including making a voice link using an Internet Protocol (e.g., SIP, WebRTP, etc.) connection, or using a cellular voice connection, for instance, with the personal device initiating a call to the server or the server initiating a voice call to the personal device (in a manner that is not subject to the forwarding setting for other calls made to the device) or using a call transfer function of the telephone network thereby removing the server application from the call. A typical interaction might involve the following exchange:
[Assistant]: Hi. I'm Dan's assistant Samantha.
[Caller]: This is Cora. I wanted to talk to Dan about the press release we're working on.
[Assistant]: He's currently in his car. Would you like me to see if he's available to speak with you?
[Caller]: That would be great.
[Assistant]: ok. Hold on a second and I'll see.

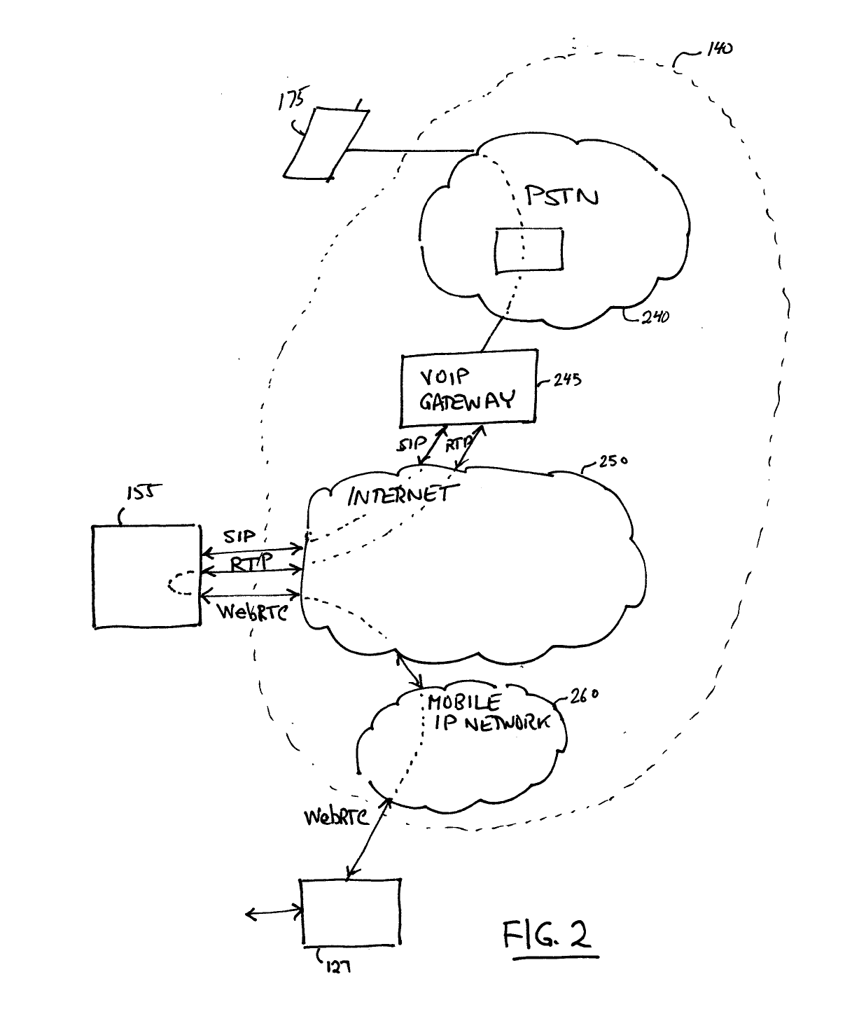

Referring to FIG. 2, in an embodiment of the system 100 described above, a remove calling device 175 makes a call via the Public Switched Telephone Network (PSTN) 240 to a Voice-over-IP (VoIP) gateway 245. As discussed above, the user has previously redirected the telephone number of the user's personal device so that calls to it are redirected, in this case to the VoIP gateway. Prior to the call being made, the server application 155 has registered with the VoIP gateway to be notified of call's made to the user's number. When the call comes in, in this example, the VoIP gateway uses a Session Initiation Protocol (SIP) to interact with the server application 155 with the public Internet 250. The server application 155 accepts the call, at which point a Real-Time Protocol (RTP) audio connection is made between the VoIP gateway 245 and the server application 155 for the call. Previously, the client application 127 has registered with the server application 155 using a WebRTC protocol over a mobile IP network 260 (e.g., a 4G cellular network) and over the public Internet 260, and upon receiving the call for the user, the server application initiates WebRTC audio communication with the client application (e.g., using a Secure RTP (SRTP) protocol set up as part of the WebRTC interaction between the server application and the client application). At this point the server application passes audio data between the caller and the client application. When the server application “transfers” the call to the client, it either stays in the audio path (e.g., bridging the SIP-RTP connection and the WebRTC-SRTP connection), or alternatively, the server application sends a SIP command (e.g., REFER) to the VoIP gateway causing a redirection of the audio connection to pass directly between the VoIP gateway and the user's device 125.

In other somewhat more complex call handling, the user interacts with the system (i.e., implemented at the client application 127 and/or the server application 155), generally using recognized speech input (or in some embodiments, a limited number of manual inputs, for example, using predefined buttons). For example, in response to hearing the initial exchange with the caller, the user may provide a command that causes one of a number of different actions to be taken. Such actions may include, for example, completing the call (e.g., in a response such as “please put her through”), providing the caller with a predefined synthesized response, or a text message (i.e., a Short Message Service (SMS) message), providing a recorded response, forwarding the call to a predefined or selected alternate destination (e.g., to the user's secretary), etc.

The system also accepts text messages (e.g., SMS messages, email etc.) at the server on behalf of the user, and announces the arrival in a similar manner as with incoming voice calls. For instance, the arrival of the text message is announced audio to the user, and optionally (e.g., according to input from the user) the full content of the message is read to the user, and a response may be sent in return (either by default, such as “Dan is driving and can't answer right now”, or by voice input (by speech-to-text or selection of predefined responses).

As an example interaction, when a text message is received for the user at the server, the server causes audio to be played to the user: “You have a text message from ZZZ. Shall I read it to you?” where ZZZ is the identity of the sender of the text message. The assistant then listens for a reply from the driver, and if the reply is not heard, the assistant leaves the message in the message queue on the cell phone. However, if the driver says something (“play me the message”, for instance), then the assistant reads the message to the driver using a text-to-speech system, while marking the message in the message queue as “read”.

If the message is played to the driver, the assistant then asks “would you like me to send a delivery receipt?”. Upon hearing a response from the driver, the assistant returns a text message to the sender saying “This message was delivered by [driver ID]'s voice assistant”. If the driver does not respond, then the assistant simply terminates the transaction, leaving the message in the message inbox for later retrieval. The assistant may be configured for more detailed replies, as described below.

The assistant can market itself to the caller as well. When a call or message is handled, the assistant announces itself to the caller and opens the channel to the user. Optionally, while waiting for the driver to respond, the assistant could also announce to the caller: “I am an automated assistant, freely available at YYYY.com”. Alternatively, it might say: “I'm an automated assistant. Stay on the line after the call and I can tell you about myself and send a link to download me to your phone for free.” or “This automated assistant is available—press 1 for more information”. At the end of the call, the assistant could provide some basic information on how the assistant works and, if the caller agrees, send an SMS with a WWW link to download the app. Of course, for the messaging application, the notifications are returned to the sender in text form.

The assistant may modify its actions based on the history of a particular user and on a record of past interactions. For instance, if a particular user is always shunted to voicemail, the assistant may “learn” to recognize this situation, and if this caller calls it can automatically pass the call to voicemail (possibly subject to override by the driver). It may learn this circumstance using standard machine learning protocols, or with a neural network system.

While buttons are not ordinarily used in user interactions involving the attentive assistant, they may provide “emergency” services. For instance, a call that has been connected through inadvertent miss-communication between the driver and the assistant may be terminated using the “hang up” button on the driver's steering wheel (as he might do after a standard Bluetooth enabled phone call). On the other hand, if the driver did not respond verbally to an offer to connect a call, but wanted the call connected, a push of the “call” button on the steering wheel could be interpreted as a signal to the application that the driver wanted to take the call. Other uses of the steering wheel buttons may enhance the non-standard use of this attentive assistant.

The assistant also uses machine learning to better handle calls. It starts by creating a profile for each caller based the incoming phone number.

All available metadata (contacts in the user's address book, information in the user's social graph, lookups of where the phone is based on exchange, etc) and the responses the user gives are associated with this profile. This information, along with any context about the current call (date, time, location, how fast the user is driving, etc.), is used to predict the way a new call should be handled, using machine learning models.

For example, the first time Steve calls into the system, the assistant detects that the caller is from an unrecognized number and introduces herself and explain how she works (“Hi. Dan is currently driving. I'm his AI assistant and help him answer his calls and take messages. Can you let me know what this is regarding?”). The next time Steve calls, the assistant identifies the caller and recognizes that in a similar situation the user wanted to speak immediately, so does not ask what the call is in regards to: “Hi, Steve. It's nice to talk to you again. Let me see if Dan's able to talk”

Over time, as more data is fed into the system to create better models, the AI assistant becomes better at predicting what the appropriate action is and simply does it automatically.

It should be understood that various alternative implementations can provide the functionality described above. For example, some of all of the functions described above as being implemented at the server may be hosted in the vehicle, for example, on the user's communication device. Therefore, there may not be separate client and server software. An example of some but not all of the functionality described above for the server being hosted in the vehicle involves speech synthesis to the user and speech recognition of speech of the user being performed in the vehicle, and encoded information (e.g., text rather than audio) being passed between the client and the server. In some implementations, no software is required in the vehicle with the user's phone being set to automatically answer calls from the server, with the audio link between the server and the user device being formed over a cellular telephone connection rather than being form, for example, over the WebRTC connection described above. Furthermore, certain communication functions are described as using the Public Switched Telephone Network or the public Internet. Alternative implementations may use different communication infrastructure, for example, with the system being entirely hosted within a cellular telephone/communication infrastructure (e.g., within an LTE based infrastructure).

As described above, many features of the system are implemented in software that executes at a user device and/or at a server computer. The software may include instructions for causing a processor at the user device or server computer to perform functions described above, with the software being stored on a non-transitory machine-readable medium, or transmitted (e.g., to the user device) from a storage to the user device or server computer over a communication network (e.g., downloading an application (“app”) to the user's smartphone).

It is to be understood that the foregoing description is intended to illustrate and not to limit the scope of the invention, which is defined by the scope of the appended claims. Other embodiments are within the scope of the following claims.

What is claimed is:

1. A method for assisting communication via a user device, the method comprising:
receiving at a server a voice-based call from a calling device for the user device, the voice-based call having been made to an address associated with the user device, including establishing a first two-way audio link between the server and the calling device;
establishing a second two-way audio link between the server and the user device;
responding to the call, including
sending a first audio stream over the first link to the calling device, said audio stream including a spoken message for alerting a calling party to the involvement of an automated assistant,
receiving a second audio stream over the first link, and
sending a third audio stream over the second link, said third audio stream including a portion of the second audio stream;
processing audio received over at least one of the first link and the second link at the server, including
waiting to receive a first voice response of a first predetermined type over the second link, and
if the first voice response is received, causing the calling device and the user device to be joined by a two-way audio link.

2. The method of claim 1 wherein the sending of the third audio stream is performed at least in part during receiving of the second audio stream.

3. The method of claim 2 wherein the third audio stream is a delay of the second audio stream.

4. The method of claim 1 wherein the voice response from the user device is not sent to the calling device.

5. The method of claim 1 wherein the first voice response consists of no spoken response.

6. The method of claim 1 wherein processing the audio further includes
waiting to receive a second voice response of a second predetermined type over the second link, and
if the second voice response is received, causing the calling device and a voice messaging server to be joined by a two-way audio link.

7. The method of claim 1 wherein establishing the second link is performed prior to receiving the voice-based call.

8. The method of claim 7 where the second link comprises a packet-based link.

9. The method of claim 1 wherein causing the calling device and the user device to be joined by a two-way audio link comprises bridging the first link and the second link.

10. The method of claim 1 wherein causing the calling device and the user device to be joined by a two-way audio link comprises redirecting the voice-based call to the user device.

11. A method for assisting communication via a user device, the method comprising:
establishing a second two-way audio link between a server and a user device;
responding to a call made to the user device, including
receiving a third audio stream over the second link, said third audio stream including a portion of the second audio stream received from a calling device at the server;
processing audio received at the user device from a user, including
receiving a first voice response of a first predetermined type,
wherein first voice response causes the calling device and the user device to be joined by a two-way audio link.

12. The method of claim 11 wherein the receiving of the third audio stream is performed at least in part during receiving of the second audio stream at the server.

13. The method of claim 12 wherein the third audio stream is a delay of the second audio stream.

14. The method of claim 11 wherein establishing the second link is performed to the server receiving the second audio stream.

15. The method of claim 14 where the second link comprises a packet-based link.

16. The method of claim 1 wherein causing the calling device and the user device to be joined by a two-way audio link comprises causing bridging of the first link and the second link.

17. The method of claim 1 wherein causing the calling device and the user device to be joined by a two-way audio link comprises causing redirection of the voice-based call to the user device.
